(19) United States
(12) Patent Application Publication
(10) Pub. No.: US 2002/0018506 A1
(43) Pub. Date: Feb. 14, 2002

(54) Line selection of molecular fluorine laser emission

(75) Inventor: Klaus Vogler, Gottingen (DE)

Correspondence Address: Andrew V. Smith, Sierra Patent Group, Ltd., P.O. Box 6149, Stateline, NV, 89449, US

(73) Assignee: Lambda Physik AG

(21) Appl. No.: 09/883,127

(22) Filed: Jun. 15, 2001

Related U.S. Application Data
(60) Provisional application No. 60/212,257, filed on Jun. 19, 2000.
(60) Provisional application No. 60/296,833, filed on Jun. 8, 2001.

(51) Int. Cl. H01S 3/22; H01S 3/223

(52) U.S. Cl. 372/55

(57) ABSTRACT

A molecular fluorine laser system emitting a narrow bandwidth laser beam and having efficient line-selection of a main line λ₁ of multiple closely-spaced lines around 157 nm includes a discharge chamber filled with a laser gas including molecular fluorine and a buffer gas, a gas handling module for periodically replenishing the molecular fluorine in the discharge chamber for maintaining said gas mixture at a selected composition, multiple electrodes within the discharge chamber and connected to a discharge circuit for energizing the molecular fluorine, and a resonator including the discharge chamber for generating a laser beam around 157 nm. The resonator further includes line-selection optics for selecting a main line λ₁ and suppressing a secondary line λ₂ of said plurality of closely-spaced lines. The line-selection optics include a line-selection package on the opposite of an output coupling side of the chamber and/or a solid element on the outcoupling side of the chamber having an interference maximum at the main line and an interference minimum at the secondary line. A contrast ratio of the main line to the secondary line in the laser beam is at least 100. The laser system further includes an enclosure maintained substantially free of VUV photoabsorbing species wherein the laser beam propagates within the enclosure between the resonator and an application process.

### PRIORITY

This application claims the benefit of priority to U.S. provisional patent applications No. 60/212,257, filed Jun. 19, 2000, and serial no. not yet assigned, filed Jun. 7, 2001, entitled “Line Selection of Molecular Fluorine Laser Emission,” by inventor Dr. Klaus Vogler.

### BACKGROUND OF THE INVENTION

1. Field of the Invention

The invention relates to line-selection for a molecular fluorine laser, and particularly to providing line-selecting optics in the front optics module of the F₂-laser for improving the contrast ratio of the intensity I(λ₁) of a main emission line around λ₁≈157.63094 nm compared with the intensity I(λ₂) of a secondary emission line around λ₂≈157.52433 nm using an interference device in a front, output coupling side of the laser resonator, such as may be included in an output coupling optical element, preferably in combination with line-selection optics located at the rear side of the resonator.

2. Discussion of the Related Art

Optical Lithography using refractive imaging optical systems includes a laser system for generating a stable, narrow bandwidth output beam for producing high resolution images of a mask structure on an exposed resist. Any residual intensities of the radiation outside the selected spectral range may dramatically reduce the optical imaging of high numerical aperture projection lenses which are designed for highly monochromatic illumination radiation to print small structures onto wafers. It is desired, then, to have a short wavelength laser for generating a beam with a high degree of spectral purity.

The molecular fluorine laser is a good candidate as an exposure radiation source due its short wavelength emission between 157 nm and 158 nm. The output emission spectrum of the F₂-laser around 157 nm is characterized by multiple lines including two or three closely-spaced lines. A first or main emission line has a wavelength around λ₁≈157.631 nm and a secondary line has a wavelength around λ₂≈157.524 nm. Each line has a natural linewidth of around 15 pm. The characteristic intensity, or contrast, ratio between the main and secondary lines is I(λ₁)/I(λ₂)≈7 (See V. N. Ishenko, S. A. Kochubel, and A. M. Razher, Sov. Journ. QE-16, 5 (1986)). This low contrast ratio indicates that the natural bandwidth of the F₂-laser is effectively above 100 pm.

It is desired to suppress the secondary line to achieve a high contrast ratio that reduces the effective bandwidth to depend substantially only on the linewidth of the main line. Due to the gain within the resonator of the F₂-laser, line selection by using only a single dispersion element, such as a prism or a grating, may not achieve the desired high contrast ratio, or suppression of the secondary line at λ₂. It is therefore desired to have an improved resonator design for the F₂-laser that provides a contrast ratio of more than 100, and preferably more than 500, to reduce the effective bandwidth and obtain a desired high spectral purity beam.

### RECOGNIZED IN THE PRESENT INVENTION

It is recognized in the present invention that a F₂ laser beam undergoes far fewer round trips within the laser resonator than typical laser systems. The radiation may undergo less than two or even around one or less than one round trip. Due to this, radiation is not as greatly influenced by optics in the F₂ laser resonator as it is in typical laser resonators, wherein the radiation may undergo several tens or hundreds of round trips, each time being influenced by the resonator optics. Even in KrF and ArF excimer lasers, cousins of the molecular fluorine laser, the radiation will undergo several round trips in the resonator. Of particular significance, a substantial portion of the emission intensity I(λ₂) of the secondary line at λ₂ is due to radiation that originates in the laser chamber and travels on a one way path toward the output coupling side of the resonator. This radiation is not selectively influenced by dispersive line selection optics located on the other side of the chamber, such as within a rear optics module, within the resonator. Therefore, it is recognized herein that this radiation will only be selectively influenced by any line selection optics on the outcoupling side of the chamber within or without the laser resonator. Thus, it is desired to provide a F₂-laser with advantageous line-selection optics on the outcoupling side of the discharge chamber.

### SUMMARY OF THE INVENTION

It is therefore an object of the invention to provide a short wavelength laser, such as a F₂-laser emitting around 157 nm, for generating an output beam with a high degree of spectral purity.

It is a further object of the invention to provide a F₂-laser having a contrast ratio I(λ₁)/I(λ₂) between its characteristic closely-spaced main and secondary emission lines around 157 nm that is greater than 100, and preferably 500 or more.

In view of these objects, a molecular fluorine laser system emitting a narrow bandwidth laser beam and having efficient line-selection of a main line λ₁ of multiple closely-spaced lines around 157 nm is provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam around 157 nm,. The resonator further includes a solid element having a transmission maximum at or near said main line λ₁ and a transmission minimum at or near a secondary line λ₂ of the multiple closelyspaced lines to suppress the secondary line. The solid element is positioned on an output coupling side of the chamber. The resonator further includes an additional line-selection package on the opposite of the output coupling side of the chamber.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element comprising a birefringent bulk material. The solid element has a transmission maximum at or near the main line λ₁ and a transmission minimum at or near a secondary line λ₂ of the multiple closely-spaced lines to suppress the secondary line. The solid element is positioned on an output coupling side of the chamber. The resonator further includes an additional line-selection package on the opposite of the output coupling side of the chamber.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element comprising a VUV transparent block with a thin coating formed thereon. The solid element has a transmission maximum at or near the main line λ₁ and a transmission minimum at or near a secondary line λ₂ of the multiple closely-spaced lines to suppress the secondary line. The solid element is positioned on an output coupling side of the chamber. The resonator further includes an additional line-selection package on the opposite of the output coupling side of the chamber.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element having a partially reflective inner surface as a resonator reflector. The solid element has a transmission maximum at or near the main line λ₁ and a transmission minimum at or near a secondary line λ₂ of the multiple closely-spaced lines to suppress the secondary line. The solid element also output couples the laser beam. The resonator also includes an additional line-selection package on the opposite of the output coupling side of the chamber.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element made of a birefringent bulk material and having a partially reflective inner surface as a resonator reflector. The solid element has a transmission maximum at or near the main line λ₁ and a transmission minimum at or near a secondary line λ₂ of the multiple closely-spaced lines to suppress the secondary line. The solid element also outcouples the laser beam. The resonator further includes an additional line-selection package on the opposite of the output coupling side of the chamber.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element made of a VUV transparent block with a thin coating formed thereon and having a partially reflective inner surface as a resonator reflector. The solid element has a transmission maximum at or near the main line λ₁ and a transmission minimum at or near a secondary line λ₂ of the multiple closely-spaced lines to suppress the secondary line. The solid element also outcouples the laser beam. The resonator further includes an additional line-selection package on the opposite of the output coupling side of the chamber.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element having a partially reflective inner surface as a resonator reflector. The solid element has a transmission maximum at or near the main line λ₁ and a transmission minimum at or near a secondary line λ₂ of the multiple closely-spaced lines to suppress the secondary line. The solid element also output couples the laser beam.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element made of a birefringent bulk material and having a partially reflective inner surface as a resonator reflector. The solid element has a transmission maximum at or near the main line λ₁ and a transmission minimum at or near a secondary line λ₂ of the multiple closely-spaced lines to suppress the secondary line. The solid element also outcouples the laser beam.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element made of a VUV transparent block with a thin coating formed thereon and having a partially reflective inner surface as a resonator reflector. The solid element has a transmission maximum at or near the main line λ₁ and a transmission minimum at or near a secondary line λ₂ of the multiple closely-spaced lines to suppress the secondary line. The solid element also outcouples the laser beam.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element having a transmission maximum at or near the main line λ₁ and a transmission minimum at or near a secondary line λ₂ of the multiple closely-spaced lines to suppress the secondary line. The solid element is positioned on an output coupling side of the chamber. The system also includes an amplifier for boosting an energy of the laser beam generated from the resonator.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element made of a birefringent bulk material. The solid element has a transmission maximum at or near the main line λ₁ and a transmission minimum at or near a secondary line λ₂ of the multiple closely-spaced lines to suppress the secondary line. The solid element is positioned on an output coupling side of the chamber. The system also includes an amplifier for boosting an energy of the laser beam generated from the resonator.

A molecular fluorine laser system emitting a narrow bandwidth laser beam and having efficient line-selection of a main line λ₁ of multiple closely-spaced lines around 157 nm is also provided. The system includes a discharge chamber filled with a laser gas including molecular fluorine and a buffer gas, multiple electrodes within the discharge chamber and connected to a discharge circuit for energizing the molecular fluorine, and a resonator including the discharge chamber for generating a laser beam. The resonator further includes a solid element made of a VUV transparent block with a thin coating formed thereon. The solid element has a transmission maximum at or near the main line λ₁ and a transmission minimum at or near a secondary line λ₂ of the multiple closely-spaced lines to suppress the secondary line. The solid element is positioned on an output coupling side of the chamber. The system further includes an amplifier for boosting an energy of the laser beam generated from the resonator.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element having a transmission maximum at or near the main line λ₁ and a transmission minimum at or near a secondary line λ₂ of the multiple closely-spaced lines to suppress the secondary line. The solid element is positioned on an output coupling side of the chamber. The system also includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element made of a birefringent bulk material. The solid element has a transmission maximum at or near the main line λ₁ and a transmission minimum at or near a secondary line λ₂ of the multiple closely-spaced lines to suppress the secondary line. The solid element is positioned on an output coupling side of the chamber. The system further includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element made of a VUV transparent block with a thin coating formed thereon. The solid element has a transmission maximum at or near the main line λ₁ and a transmission minimum at or near a secondary line λ₂ of the multiple closely-spaced lines to suppress the secondary line. The solid element is positioned on an output coupling side of the chamber. The system further includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element having a reflectivity maximum at or near the main line λ₁ and a reflectivity minimum at or near a secondary line λ₂ of the multiple closely-spaced lines to suppress the secondary line. The solid element also outcouples the laser beam. The system also includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element made of a birefringent bulk material. The solid element has a reflectivity maximum at or near the main line λ₁ and a reflectivity minimum at or near a secondary line λ₂ of the multiple closely-spaced lines to suppress the secondary line. The solid element also output couples the laser beam. The system also includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element made of a VUV transparent block with a thin coating formed thereon. The solid element has a reflectivity maximum at or near the main line λ₁ and a reflectivity minimum at or near a secondary line λ₂ of the multiple closely-spaced lines to suppress the secondary line. The solid element also output couples the laser beam. The system also includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element for selecting a main line λ₁ and suppressing a secondary line λ₂ of the multiple closely-spaced lines. The solid element is disposed on an output coupling side of the discharge chamber. The resonator also includes an additional line-selection package on the opposite of the output coupling side of the chamber. The system further includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element made of a birefringent bulk material. The solid element is for selecting a main line λ₁ and suppressing a secondary line λ₂ of the multiple closely-spaced lines. The solid element is disposed on an output coupling side of the discharge chamber. The resonator also includes an additional line-selection package on the opposite of the output coupling side of the chamber. The system further includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes a solid element made of a VUV transparent block with a thin coating formed thereon. The solid element is for selecting a main line λ₁ and for suppressing a secondary line λ₂ of the multiple closely-spaced lines. The solid element is disposed on an output coupling side of the discharge chamber. The resonator also includes an additional line-selection package on the opposite of the output coupling side of the chamber. The system also includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes line-selection optics for selecting a main line λ₁ and suppressing a secondary line λ₂ of the multiple closely-spaced lines. The line-selection optics include a line-selection package on the opposite of an output coupling side of the chamber. A contrast ratio of the main line to the secondary line in the laser beam is at least 100. The system further includes an enclosure maintained substantially free of VUV photoabsorbing species wherein the laser beam propagates within the enclosure between the resonator and an application process.

A molecular fluorine laser system emitting a narrow bandwidth laser beam and having efficient line-selection of a main line λ₁ of multiple closely-spaced lines around 157 nm is further provided. The system includes a discharge chamber filled with a laser gas including molecular fluorine and a buffer gas, a gas handling module for periodically replenishing the molecular fluorine in the discharge chamber for maintaining the gas mixture at a selected composition, multiple electrodes within the discharge chamber and connected to a discharge circuit for energizing the molecular fluorine, and a resonator including the discharge chamber for generating a laser beam around 157 nm. The resonator further includes line-selection optics for selecting a main line λ₁ and suppressing a secondary line λ₂ of the multiple closely-spaced lines. The line-selection optics include a line-selection package on the opposite of an output coupling side of the chamber. A contrast ratio of the main line to the secondary line in the laser beam is at least 500. The system further includes an enclosure maintained substantially free of VUV photoabsorbing species wherein the laser beam propagates within the enclosure between the resonator and an application process.

### BRIEF DESCRIPTION OF THE DRAWINGS

FIG. 1 schematically shows a molecular fluorine laser system in accord with a preferred embodiment.

FIG. 2a schematically shows a first resonator arrangement in accord with the preferred embodiment.

FIG. 2b schematically shows a second resonator arrangement in accord with the preferred embodiment.

FIG. 3a schematically shows a third resonator arrangement in accord with the preferred embodiment.

FIG. 3b schematically shows a fourth resonator arrangement in accord with the preferred embodiment.

### INCORPORATION BY REFERENCE

What follows is a cite list of references each of which is, in addition to those references cited above in the priority section, hereby incorporated by reference into the detailed description of the preferred embodiment below, as disclosing alternative embodiments of elements or features of the preferred embodiments not otherwise set forth in detail below. A single one or a combination of two or more of these references may be consulted to obtain a variation of the preferred embodiments described in the detailed description below. Further patent, patent application and non-patent references are cited in the written description and are also incorporated by reference into the preferred embodiment with the same effect as just described with respect to the following references:

U.S. patent applications Nos. 09/453,670, 09/447,882, 09/317,695, 09/574,921, 09/512,417, 09/599,130, 09/694,246, 09/712,877, 091738,849, 09/718,809, 09/733,874, and 09/780,124, each of which is assigned to the same assignee as the present application; and

U.S. Pat. Nos. 6,154,470, 6,157,662, 6,219,368, and 5,901,163; and

E. Hecht, Optics, Addison-Wesley, ch. 8-9 (1987);

W. C. Driscoll, ed., Handbook of Optics, McGraw-Hill, pp. 8-111; (1978);

Bloom, “Modes of a Laser Resonator Containing Filtered Birefringent Plates”, J. Opt. Soc. Am., 64, p.447 (1974);

everything in the appendix to this application; and

all patent, patent application and non-patent references mentioned in the background or specification of this application.

### DETAILED DESCRIPTION OF THE PREFERRED EMBODIMENT

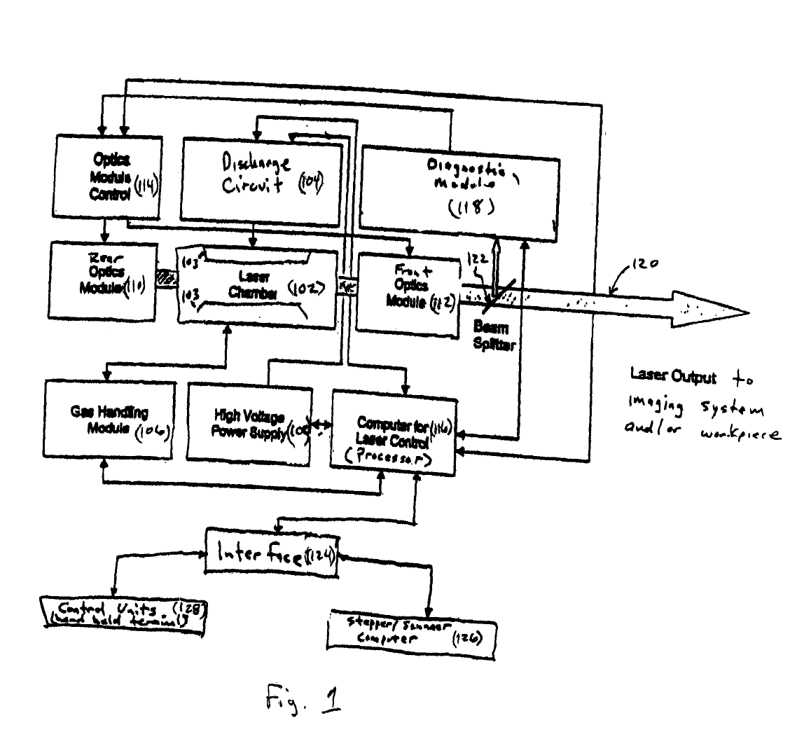

Referring to FIG. 1, an excimer or molecular fluorine laser system is schematically shown according to a preferred embodiment. The preferred gas discharge laser system is a VUV laser system, such as a molecular fluorine (F₂) laser system, for use with a vacuum ultraviolet (VUV) lithography system. Alternative configurations for laser systems for use in such other industrial applications as TFT annealing, photoablation and/or micromachining, e.g., include configurations understood by those skilled in the art as being similar to and/or modified from the system shown in FIG. 1 to meet the requirements of that application. For this purpose, alternative DUV or VUV laser system and component configurations are described at U.S. patent applications Nos. 09/317,695, 09/130,277, 09/244,554, 09/452,353, 09/512,417, 09/599,130, 09/694,246, 09/712,877, 09/574,921, 09/738,849, 09/718,809, 09/629,256, 09/712,367, 09/771,366, 09/715,803, 09/738,849, 60/202,564, 60/204,095, 09/741,465, 09/574,921, 09/734,459, 09/741,465, 09/686,483, 09/715,803, and 09/780,124, and U.S. Pat. Nos. 6,005,880, 6,061,382, 6,020,723, 5,946,337, 6,014,206, 6,157,662, 6,154,470, 6,160,831, 6,160,832, 5,559,816, 4,611,270, 5,761,236, 6,212,214, 6,154,470, and 6,157,662, each of which is assigned to the same assignee as the present application and is hereby incorporated by reference.

The system shown in FIG. 1 generally includes a laser chamber 102 (or laser tube including a heat exchanger and fan for circulating a gas mixture within the chamber 102 or tube) having a pair of main discharge electrodes 103 connected with a solid-state pulser module 104, and a gas handling module 106. The gas handling module 106 has a valve connection to the laser chamber 102 so that halogen, rare and buffer gases, and preferably a gas additive, may be injected or filled into the laser chamber, preferably in premixed forms (see U.S. patent application Nos. 09/513,025, which is assigned to the same assignee as the present application, and U.S. Pat. No. 4,977,573, which are each hereby incorporated by reference) for ArF, XeCl and KrF excimer lasers, and halogen and buffer gases, and any gas additive, for the F₂ laser. For the high power XeCl laser, the gas handling module may or may not be present in the overall system. The solid-state pulser module 104 is powered by a high voltage power supply 108. A thyratron pulser module may alternatively be used. The laser chamber 102 is surrounded by optics module 110 and optics module 112, forming a resonator. The optics module may include only a highly reflective resonator reflector in the rear optics module 110 and a partially reflecting output coupling mirror in the front optics module 112, such as is preferred for the high power XeCl laser. The optics modules 110 and 112 may be controlled by an optics control module 114, or may be alternatively directly controlled by a computer or processor 116, particular when line-narrowing optics are included in one or both of the optics modules 110, 112, such as is preferred when KrF, ArF or F₂ lasers are used for optical lithography.

The processor 116 for laser control receives various inputs and controls various operating parameters of the system. A diagnostic module 118 receives and measures one or more parameters, such as pulse energy, average energy and/or power, and preferably wavelength, of a split off portion of the main beam 120 via optics for deflecting a small portion of the beam toward the module 118, such as preferably a beam splitter module 122. The beam 120 is preferably the laser output to an imaging system (not shown) and ultimately to a workpiece (also not shown) such as particularly for lithographic applications, and may be output directly to an application process. The laser control computer 116 may communicate through an interface 124 with a stepper/scanner computer, other control units 126, 128 and/or other external systems.

The laser chamber 102 contains a laser gas mixture and includes one or more preionization electrodes (not shown) in addition to the pair of main discharge electrodes 103. Preferred main electrodes 103 are described at U.S. patent application No. 09/453,670 for photolithographic applications, which is assigned to the same assignee as the present application and is hereby incorporated by reference, and may be alternatively configured, e.g., when a narrow discharge width is not preferred. Other electrode configurations are set forth at U.S. Pat.Nos. 5,729,565 and 4,860,300, each of which is assigned to the same assignee, and alternative embodiments are set forth at U.S. Pat. Nos. 4,691,322, 5,535,233 and 5,557,629, all of which are hereby incorporated by reference. Preferred preionization units are set forth at U.S. patent applications Nos. 09/692,265 (particularly preferred for KrF, ArF, F₂ lasers), 09/532,276 and 09/247,887, each of which is assigned to the same assignee as the present application, and alternative embodiments are set forth at U.S. Pat. Nos. 5,337,330, 5,818,865 and 5,991,324, all ofthe above patents and patent applications being hereby incorporated by reference.

The solid-state or thyratron pulser module 104 and high voltage power supply 108 supply electrical energy in compressed electrical pulses to the preionization and main electrodes 103 within the laser chamber 102 to energize the gas mixture. Components of the preferred pulser module and high voltage power supply may be described at U.S. patent applications Nos. 09/640,595, 60/198,058, 60/204,095, 09/432,348 and 09/390,146, and 60/204,095, and U.S. Pat. Nos. 6,005,880, 6,226,307 and 6,020,723, each of which is assigned to the same assignee as the present application and which is hereby incorporated by reference into the present application. Other alternative pulser modules are described at U.S. Pat. Nos. 5,982,800, 5,982,795, 5,940,421, 5,914,974, 5,949,806, 5,936,988, 6,028,872, 6,151,346 and 5,729,562, each of which is hereby incorporated by reference.

The laser resonator which surrounds the laser chamber 102 containing the laser gas mixture includes optics module 110 preferably including line-narrowing optics for a line narrowed excimer or molecular fluorine laser such as for photolithography, which may be replaced by a high reflectivity mirror or the like in a laser system wherein either line-narrowing is not desired (for TFT annealling, e.g.), or if line narrowing is performed at the front optics module 112, or a spectral filter external to the resonator is used, or if the line-narrowing optics are disposed in front of the HR mirror, for narrowing the bandwidth of the output beam. In accord with a preferred embodiment herein, optics for selecting one of multiple lines around 157 nm may be used, e.g., one or more dispersive prisms or birefringent plates or blocks, wherein additional line-narrowing optics for narrowing the selected line may be left out. The total gas mixture pressure is preferably lower than conventional systems, e.g., lower than 3 bar, for producing the selected line at a narrow bandwidth such as 0.5 pm or less without using additional line-narrowing optics.

The laser chamber 102 is sealed by windows transparent to the wavelengths of the emitted laser radiation 120. The windows may be Brewster windows or may be aligned at another angle, e.g., 5°, to the optical path of the resonating beam. One of the windows may also serve to output couple the beam or as a highly reflective resonator reflector on the opposite side of the chamber 102 as the beam is outcoupled.

After a portion of the output beam 120 passes the outcoupler of the optics module 112, that output portion preferably impinges upon a beam splitter module 122 which includes optics for deflecting a portion of the beam to the diagnostic module 118, or otherwise allowing a small portion of the outcoupled beam to reach the diagnostic module 118, while a main beam portion 120 is allowed to continue as the output beam 120 of the laser system (see U.S. patent applications Nos. 09/771,013, 09/598,552, and 09/712,877 which are assigned to the same assignee as the present invention, and U.S. Pat. No. 4,611,270, each of which is hereby incorporated by reference. Preferred optics include a beamsplitter or otherwise partially reflecting surface optic. The optics may also include a mirror or beam splitter as a second reflecting optic. More than one beam splitter and/or HR mirror(s), and/or dichroic mirror(s) may be used to direct portions of the beam to components of the diagnostic module 118. A holographic beam sampler, transmission grating, partially transmissive reflection diffraction grating, grism, prism or other refractive, dispersive and/or transmissive optic or optics may also be used to separate a small beam portion from the main beam 120 for detection at the diagnostic module 118, while allowing most of the main beam 120 to reach an application process directly or via an imaging system or otherwise. These optics or additional optics may be used to filter out visible radiation such as the red emission from atomic fluorine in the gas mixture from the split off beam prior to detection.

The output beam 120 may be transmitted at the beam splitter module while a reflected beam portion is directed at the diagnostic module 118, or the main beam 120 may be reflected, while a small portion is transmitted to the diagnostic module 118. The portion of the outcoupled beam which continues past the beam splitter module is the output beam 120 of the laser, which propagates toward an industrial or experimental application such as an imaging system and workpiece for photolithographic applications.

Particularly for the molecular fluorine laser system, and for the ArF laser system, an enclosure (not shown) preferably seals the beam path of the beam 120 such as to keep the beam path free of photoabsorbing species. Smaller enclosures preferably seal the beam path between the chamber 102 and the optics modules 110 and 112 and between the beam splitter 122 and the diagnostic module 118. Preferred enclosures are described in detail in U.S. patent applications Nos. 09/598,552, 09/594,892 and 09/131,580, which are assigned to the same assignee and are hereby incorporated by reference, and U.S. Pat. Nos. 6,219,368, 5,559,584, 5,221,823, 5,763,855, 5,811,753 and 4,616,908, all of which are hereby incorporated by reference.

The diagnostic module 118 preferably includes at least one energy detector. This detector measures the total energy of the beam portion that corresponds directly to the energy of the output beam 120 (see U.S. Pat. Nos. 4,611,270 and 6,212,214 which are hereby incorporated by reference). An optical configuration such as an optical attenuator, e.g., a plate or a coating, or other optics may be formed on or near the detector or beam splitter module 122 to control the intensity, spectral distribution and/or other parameters of the radiation impinging upon the detector (see U.S. patent applications Nos. 09/172,805, 09/741,465, 09/712,877, 09/771,013 and 09/771,366, each of which is assigned to the same assignee as the present application and is hereby incorporated by reference).

One other component of the diagnostic module 118 is preferably a wavelength and/or bandwidth detection component such as a monitor etalon or grating spectrometer (see U.S. patent applications Nos. 09/416,344, 09/686,483, and 09/791,431, each of which is assigned to the same assignee as the present application, and U.S. Pat. Nos. 4,905,243, 5,978,391, 5,450,207, 4,926,428, 5,748,346, 5,025,445, 6,160,832, 6,160,831 and 5,978,394, all of the above wavelength and/or bandwidth detection and monitoring components being hereby incorporated by reference. In accord with a preferred embodiment herein, the bandwidth is monitored and controlled in a feedback loop including the processor 116 and gas handling module 106. The total pressure of the gas mixture in the laser tube 102 is controlled to a particular value for producing an output beam at a particular bandwidth.

Other components of the diagnostic module may include a pulse shape detector or ASE detector, such as are described at U.S. patent applications Nos. 09/484,818 and 09/418,052, respectively, each of which is assigned to the same assignee as the present application and is hereby incorporated by reference, such as for gas control and/or output beam energy stabilization, or to monitor the amount of amplified spontaneous emission (ASE) within the beam to ensure that the ASE remains below a predetermined level, as set forth in more detail below. There may be a beam alignment monitor, e.g., such as is described at U.S. Pat. No. 6,014,206, or beam profile monitor, e.g., U.S. patent application No. 09/780,124, which is assigned to the same assignee, wherein each of these patent documents is hereby incorporated by reference.

The processor or control computer 116 receives and processes values of some of the pulse shape, energy, ASE, energy stability, energy overshoot for burst mode operation, wavelength, spectral purity and/or bandwidth, among other input or output parameters of the laser system and output beam. The processor 116 also controls the line narrowing module to tune the wavelength and/or bandwidth or spectral purity, and controls the power supply and pulser module 104 and 108 to control preferably the moving average pulse power or energy, such that the energy dose at points on the workpiece is stabilized around a desired value. In addition, the computer 116 controls the gas handling module 106 which includes gas supply valves connected to various gas sources. Further functions of the processor 116 such as to provide overshoot control, energy stability control and/or to monitor input energy to the discharge, are described in more detail at U.S. patent application No. 09/588,561, which is assigned to the same assignee and is hereby incorporated by reference.

As shown in FIG. 1, the processor 116 preferably communicates with the solid-state or thyratron pulser module 104 and HV power supply 108, separately or in combination, the gas handling module 106, the optics modules 110 and/or 112, the diagnostic module 118, and an interface 124. The laser resonator which surrounds the laser chamber 102 containing the laser gas mixture includes optics module 11 0 including line-narrowing optics for a line narrowed excimer or molecular fluorine laser, which may be replaced by a high reflectivity mirror or the like in a laser system wherein either line-narrowing is not desired, or if line narrowing is performed at the front optics module 11 2, or an spectral filter external to the resonator is used for narrowing the linewidth of the output beam. Several variations of line-narrowing optics are set forth in detail below.

The laser gas mixture is initially filled into the laser chamber 102 in a process referred to herein as a “new fills”. In such procedure, the laser tube is evacuated of laser gases and contaminants, and re-filled with an ideal gas composition of fresh gas. The gas composition for a very stable excimer or molecular fluorine laser in accord with the preferred embodiment uses helium or neon or a mixture of helium and neon as buffer gas(es), depending on the particular laser being used. Preferred gas compositions are described at U.S. Pat. Nos. 4,393,405, 6,157,162 and 4,977,573 and U.S. patent applications Nos. 09/513,025, 09/447,882, 09/418,052, and 09/588,561, each of which is assigned to the same assignee and is hereby incorporated by reference into the present application. The concentration of the fluorine in the gas mixture may range from 0.003% to 1.00%, and is preferably around 0.1%. An additional gas additive, such as a rare gas or otherwise, may be added for increased energy stability, overshoot control and/or as an aftenuator as described in the Ser. No. 09/513,025 application incorporated by reference above. Specifically, for the F2-laser, an addition of xenon, krypton and/or argon may be used. The concentration of xenon or argon in the mixture may range from 0.0001% to 0.1%. For an ArF-laser, an addition of xenon or krypton may be used also having a concentration between 0.0001% to 0.1%. Forthe KrF laser, an addition of xenon or argon may be used also having a concentration between 0.0001% to 0.1%. Although the preferred embodiments herein are particularly drawn to use with a F₂ laser, some gas replenishment actions are described for gas mixture compositions of other systems such as ArF, KrF, and XeCl excimer lasers, wherein the ideas set forth herein may also be advantageously incorporated into those systems.

Halogen gas injections, including micro-halogen injections of, e.g., 1-3 milliliters of halogen gas, mixed with, e.g., 20-60 milliliters of buffer gas or a mixture of the halogen gas, the buffer gas and a active rare gas for rare gas-halide excimer lasers, per injection for a total gas volume in the laser tube 102 of, e.g., 100 liters, total pressure adjustments and gas replacement procedures may be performed using the gas handling module 106 preferably including a vacuum pump, a valve network and one or more gas compartments. The gas handling module 106 receives gas via gas lines connected to gas containers, tanks, canisters and/or bottles. Some preferred and alternative gas handling and/or replenishment procedures, other than as specifically described herein (see below), are described at U.S. Pat. Nos. 4,977,573, 6,212,214 and 5,396,514 and U.S. patent applications Nos. 09/447,882, 09/418,052, 09/734,459, 09/513,025 and 09/588,561, each of which is assigned to the same assignee as the present application, and U.S. Pat. Nos. 5,978,406, 6,014,398 and 6,028,880, all of which are hereby incorporated by reference. A xenon gas supply may be included either internal or external to the laser system according to the '025 application, mentioned above.

Total pressure adjustments in the form of releases of gases or reduction of the total pressure within the laser tube 102 may also be performed. Total pressure adjustments may be followed by gas composition adjustments if it is determined that, e.g., other than the desired partial pressure of halogen gas is within the laser tube 102 after the total pressure adjustment. Total pressure adjustments may also be performed after gas replenishment actions, and may be performed in combination with smaller adjustments of the driving voltage to the discharge than would be made if no pressure adjustments were performed in combination.

Gas replacement procedures may be performed and may be referred to as partial, mini- or macro-gas replacement operations, or partial new fill operations, depending on the amount of gas replaced, e.g., anywhere from a few milliliters up to 50 liters or more, but less than a new fill, such as are set forth in the Ser. No. 09/734,459, incorporated by reference above. As an example, the gas handling unit 106 connected to the laser tube 102 either directly or through an additional valve assembly, such as may include a small compartment for regulating the amount of gas injected (see the '459 application), may include a gas line for injecting a premix A including 1%F₂:99%Ne or other buffer gas such as He, and another gas line for injecting a premix B including 1% rare gas:99% buffer gas, for a rare gas-halide excimer laser, wherein for a F₂ laser premix B is not used. Another line may be used for total pressure additions or reductions, i.e., for flowing buffer gas into the laser tube or allowing some of the gas mixture in the tube to be released, possibly accompanying halogen injections for maintaining the halogen concentration. Thus, by injecting premix A (and premix B for rare gas-halide excimer lasers) into the tube 102 via the valve assembly, the fluorine concentration in the laser tube 102 may be replenished. Then, a certain amount of gas may be released corresponding to the amount that was injected to maintain the total pressure at a selected level. Additional gas lines and/or valves may be used for injecting additional gas mixtures. New fills, partial and mini gas replacements and gas injection procedures, e.g., enhanced and ordinary micro-halogen injections, such as between 1 milliliter or less and 3-10 milliliters, and any and all other gas replenishment actions are initiated and controlled by the processor 116 which controls valve assemblies of the gas handling unit 106 and the laser tube 102 based on various input information in a feedback loop. These gas replenishment procedures may be used in combination with gas circulation loops and/or window replacement procedures to achieve a laser system having an increased servicing interval for both the gas mixture and the laser tube windows.

A general description of the line-narrowing features of embodiments of the laser system particularly for use with photolithographic applications is provided here, followed by a listing of patent and patent applications being incorporated by reference as describing variations and features that may be used within the scope of the preferred embodiments herein for providing an output beam with a high spectral purity or bandwidth (e.g., below 1 pm and preferably 0.6 pm or less). These exemplary embodiments may be used for selecting the primary line λ₁ only, or may be used to provide additional line narrowing as well as performing line-selection, or the resonator may include optics for line-selection and additional optics for line-narrowing of the selected line, and line-narrowing may be provided by controlling (i.e., reducing) the total pressure (see U.S. patent application Ser. No. 60/212,301, which is assigned to the same assignee and is hereby incorporated by reference). Exemplary line-narrowing optics contained in the optics module 110 include a beam expander, an optional interferometric device such as an etalon or otherwise as described in the Ser. No. 09/715,803 application, incorporated by reference above, and a diffraction grating, and alternatively one or more dispersion prisms may be used, wherein the grating would produce a relatively higher degree of dispersion than the prisms although generally exhibiting somewhat lower efficiency than the dispersion prism or prisms, for a narrow band laser such as is used with a refractive or catadioptric optical lithography imaging system. As mentioned above, the front optics module may include line-narrowing optics such as may be described in any of the Ser. Nos. 09/715,803, 09/738,849, and 09/718,809 applications, each being assigned to the same assignee and hereby incorporated by reference.

Instead of having a retro-reflective grating in the rear optics module 110, the grating may be replaced with a highly reflective mirror, and a lower degree of dispersion may be produced by a dispersive prism or alternatively no line-narrowing or line-selection may be performed in the rear optics module 110. In the case of using an all-reflective imaging system, the laser may be configured for semi-narrow band operation such as having an output beam linewidth in excess of 0.6 pm, depending on the characteristic broadband bandwidth of the laser, such that additional line-narrowing of the selected line would not be used, either provided by optics or by reducing the total pressure in the laser tube.

The beam expander of the above exemplary line-narrowing optics of the optics module 110 preferably includes one or more prisms. The beam expander may include other beam expanding optics such as a lens assembly or a converging/diverging lens pair. The grating or a highly reflective mirror is preferably rotatable so that the wavelengths reflected into the acceptance angle of the resonator can be selected or tuned. Alternatively, the grating, or other optic or optics, or the entire line-narrowing module may be pressure tuned, such as is set forth in the Ser. No. 09/771,366 application and the Pat. No. 6,154,470 patent, each of which is assigned to the same assignee and is hereby incorporated by reference. The grating may be used both for dispersing the beam for achieving narrow bandwidths and also preferably for retroreflecting the beam back toward the laser tube. Alternatively, a highly reflective mirror is positioned after the grating which receives a reflection from the grating and reflects the beam back toward the grating in a Littman configuration, or the grating may be a transmission grating. One or more dispersive prisms may also be used, and more than one etalon or other interferometric device may be used.

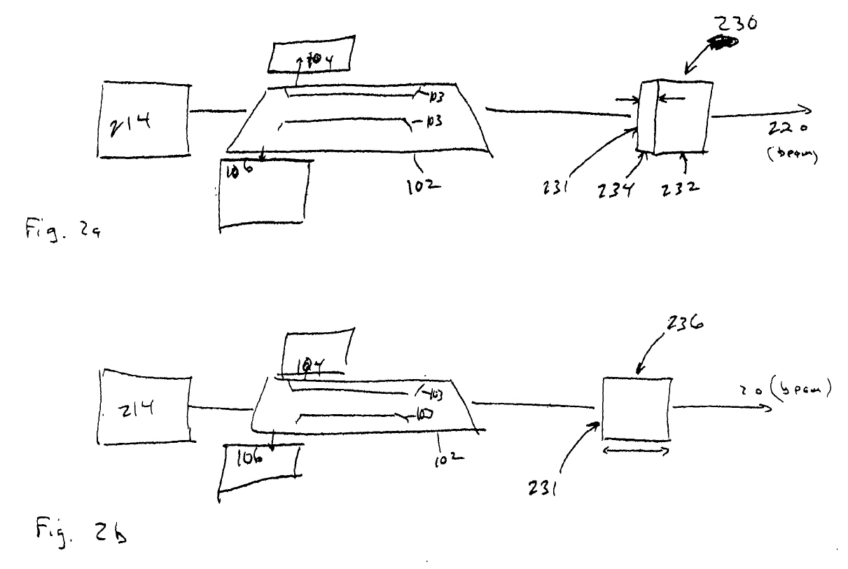

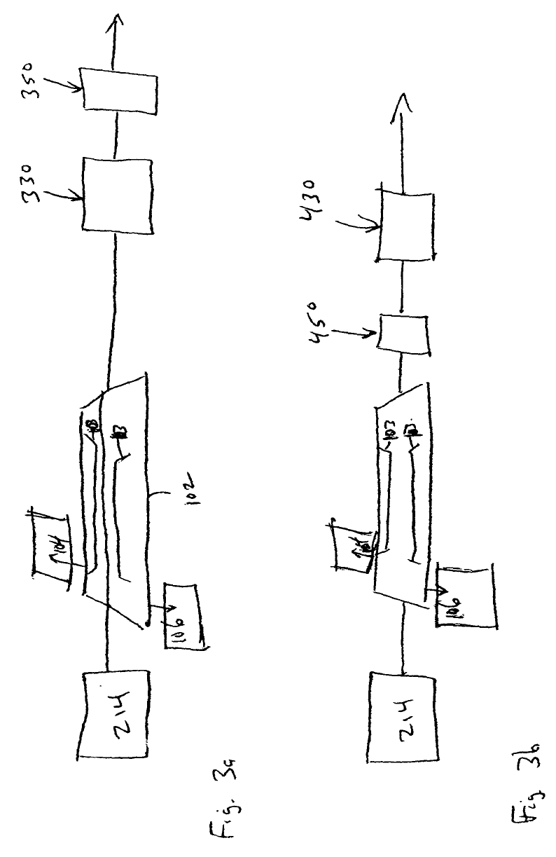

Depending on the type and extent of line-narrowing and/or selection and tuning that is desired, and the particular laser that the line-narrowing optics are to be installed into, there are many alternative optical configurations that may be used other than those specifically described below with respect to FIGS. 2a-3b. For this purpose, those shown in U.S. Pat. Nos. 4,399,540, 4,905,243, 5,226,050, 5,559,816, 5,659,419, 5,663,973, 5,761,236, 6,081,542, 6,061,382, 6,154,470, 5,946,337, 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, 5,970,082, 5,978,409, 5,999,318, 5,150,370 and 4,829,536, and German patent DE 298 22 090.3, and any of the patent applications mentioned above and below herein, may be consulted to obtain a line-narrowing configuration that may be used with a preferred laser system herein, and each of these patent references is each hereby incorporated by reference into the present application.

Optics module 112 preferably includes means for outcoupling the beam 120, such as a partially reflective resonator reflector. The beam 120 may be otherwise outcoupled such as by an intra-resonator beam splitter or partially reflecting surface of another optical element, and the optics module 112 would in this case include a highly reflective mirror. The optics control module 114 preferably controls the optics modules 110 and 112 such as by receiving and interpreting signals from the processor 116, and initiating realignment, gas pressure adjustments in the modules 110,112, or reconfiguration procedures (see the '353, '695, '277, '554, and '527 applications mentioned above).

The halogen concentration in the gas mixture is maintained constant during laser operation by gas replenishment actions by replenishing the amount of halogen in the laser tube for the preferred molecular fluorine laser herein, such that these gases are maintained in a same predetermined ratio as are in the laser tube 102 following a new fill procedure. In addition, gas injection actions such as μHls as understood from the '882 application, mentioned above, may be advantageously modified into micro gas replacement procedures, such that the increase in energy of the output laser beam may be compensated by reducing the total pressure. In contrast, or alternatively, conventional laser systems would reduce the input driving voltage so that the energy of the output beam is at the predetermined desired energy. In this way, the driving voltage is maintained within a small range around HVₒₚₜ, while the gas procedure operates to replenish the gases and maintain the average pulse energy or energy dose, such as by controlling an output rate of change of the gas mixture or a rate of gas flow through the laser tube 102. Advantageously, the gas procedures set forth herein permit the laser system to operate within a very small range around HVₒₚₜ, while still achieving average pulse energy control and gas replenishment, and increasing the gas mixture lifetime or time between new fills (see U.S. patent application No. 09/780,120, which is assigned to the same assignee as the present application and is hereby incorporated by reference).

In all of the above and below embodiments, the material used for any dispersive prisms, the prisms of any beam expanders, etalons, laser windows and the outcoupler is preferably one that is highly transparent at wavelengths below 200 nm, such as at the 157 nm output emission wavlength of the molecular fluorine laser. The materials are also capable of withstanding long-term exposure to ultraviolet light with minimal degradation effects. Examples of such materials are CaF₂, MgF₂, BaF2, LiF and SrF₂, and in some cases fluorine-doped quartz may be used. Also, in all of the embodiments, many optical surfaces, particularly those of the prisms, may or may not have an anti-reflective coating on one or more optical surfaces, in order to minimize reflection losses and prolong their lifetime.

Also, the gas composition for the F₂ laser in the above configurations uses either helium, neon, or a mixture of helium and neon as a buffer gas. The concentration of fluorine in the buffer gas preferably ranges from 0.003% to around 1.0%, and is preferably around 0.1%. However, if the total pressure is reduced for narrowing the bandwidth, then the fluorine concentration may be higher than 0.1%, such as may be maintained between 1 and 7 mbar, and more preferably around 3-5 mbar, notwithstanding the total pressure in the tube or the percentage concentration of the halogen in the gas mixture. The addition of a trace amount of xenon, and/or argon, and/or oxygen, and/or krypton and/or other gases (see the '025 application) may be used for increasing the energy stability, burst control, and/or output energy of the laser beam. The concentration of xenon, argon, oxygen, or krypton in the mixture may range from 0.0001% to 0.1%, and would be preferably significantly below 0.1%. Some alternative gas configurations including trace gas additives are set forth at U.S. patent application No. 09/513,025 and U.S. Pat. No. 6,157,662, each of which is assigned to the same assignee and is hereby incorporated by reference.

A line-narrowed oscillator, e.g., a set forth above, may be followed by a power amplifier for increasing the power of the beam output by the oscillator. Preferred features of the oscillator-amplifier set-up are set forth at U.S. patent applications Nos. 09/599,130 and 60/228,184, which are assigned to the same assignee and are hereby incorporated by reference. The amplifier may be the same or a separate discharge chamber 102. An optical or electrical delay may be used to time the electrical discharge at the amplifier with the reaching of the optical pulse from the oscillator at the amplifier. With particular respect to the present invention, the molecular fluorine laser oscillator has an advantageous output coupler having a transmission interference maximum at λ₁ and a minimum at λ₂, and is described in more detail below. A 157 nm beam is output from the output coupler and is incident at the amplifier of this embodiment to increase the power of the beam. Thus, a very narrow bandwidth beam is achieved with high suppression of the secondary line λ₂ and high power (at least several Watts to more than 10 Watts).

FIGS. 2a-2b show respective resonator arrangements in accord with two embodiments herein. In the first embodiment schematically shown at FIG. 2a, the resonator includes the discharge chamber 102 preferably configured as set forth above, e.g., having a pair of elongated main electrodes 103 and at least one preionization unit (not shown), and being connected to a pulser circuit 104 and gas supply system 106. The system of the molecular fluorine laser into which the resonator arrangement of FIG. 2a, as well as those of FIGS. 2b-3b (see below), is included, is preferably as described above with reference to FIG. 1, and the discussion relating to FIGS. 2a-3b will be limited to the resonator configurations shown, although these resonators are preferably for incorporation into the system of FIG. 1, e.g., for photolithographic application.

The resonator shown at FIG. 2a further includes a rear optics module 214 including a line-selection package or simply a highly reflective resonator reflector. If only an HR mirror is included in the rear optics module 214, the HR mirror may seal the discharge chamber 102. A line-selection optic such as a prism, etalon or birefringent plate may be used to seal the discharge chamber 102, as well (the same goes for the arrangements of FIGS. 2a-3b). When a line-selection package is included in the rear optics module 214, the line-selection package includes optics for selecting one of the two closelyspaced characteristic emission lines around 157 nm of the F₂-laser. The lineselection package may further include optics for further narrowing the selected line, e.g., to less than 1 pm (see, e.g., the Pat. No. 6,154,470 patent and Ser. Nos. 09/599,130 and 09/657,396 applications, assigned to the same assignee and hereby incorporated by reference).

The line-selection package may include a beam expander followed either by one or more etalons or a dispersive prism or prisms or a grating, either in Littrow or Littman configuration. Also, a beam expander may be followed by one or more etalons and a grating or dispserive prism or prisms. The line-selection package provides a contrast ratio higher than the characteristic ratio of 7.

Although these line-selection packages are possible, it is desired to use a line-selection package that does not considerably extend the resonator length, such as by using too many prisms in the beam expander, or simply by using the prism-grating combination, or a combination having more than one dispersive prism, whereby the rear optics module becomes a large extension of the overall resonator package. An alternative to the rear optics module is to provide the line-selection component or components in contact with or in a housing connected to the discharge chamber 102 or laser tube atmosphere (see the Ser. No. 09/317,695 application, incorporated by reference above).

Any of these alternative embodiments of the line-selection package at the opposite side of the resonator as the outcoupler may be advantageously combined with the output coupler 230 of FIG. 2a (or the output coupler 236 of FIG. 2b, described below). That is, the line-selection package of the rear optics module 214 (or as set forth in the '695 application), improves the contrast ratio to perhaps 20-100, which is advantageous over the characteristic contrast ratio of 7. However, the output coupler 230 of the preferred embodiment provides a still higher contrast ratio, e.g., above 100 and perhaps as high as 500 or above.

Line narrowing optics (not shown) may be included within the resonator on the outcoupling side of the chamber 102, such as in the front optics module 112 of FIG. 1, and as set forth in the Ser. Nos. 09/718,809, 09/715,803 and 09/738,849 applications, each of which is assigned to the same assignee, and in U.S. Pat. No. 5,852,627, each of which is hereby incorporated by reference. When these line-narrowing optics, or variations thereof as understood by one skilled in the art, are used, careful additional beam steering means might be used for aligning the optics with the rest of the resonator. This beam steering implies losses, and so it is preferred to use an amplifier after the outcoupler in this embodiment to increase the power of the beam (see the Ser. Nos. 09/599,130 and 60/228,184 applications, incorporated by reference above).

The outcoupler 230 of a preferred embodiment in accordance with the arrangement set forth at FIG. 2a, generally has a periodic transmission function having a maximum at or near λ₁ and a minimum at or near λ₂. As such, the preferred outcoupler, and those shown at FIGS. 2a and 2b, i.e., outcouplers 230 and 236, has a partially reflecting surface 231 which serves as a resonator reflector of the resonator. In this way, the line-selection preformed at the block outcoupler 230 is actually performed extra-cavity. An alternative would be that the partially reflecting resonator reflector surface is formed after the line-selection providing portion such as at the back surface of the outcoupler 230 or 236, or as provided by an interferometric outcoupler (see the Ser. No. 09/715,803 application and other references set forth and incorporated by reference above), and in this case, the outcoupler 230, 236 has a reflectivity maximum at or near λ₁ and a minimum at or near λ₂.

The resonator, including the reflectivity of the outcoupler being reduced and the discharge circuit controlling the temporal profile of the laser pulse, may be arranged such that the beam undergoes less than one roundtrip. In this third configuration, the block 230 would be arranged with a transmission function maximum at λ₁ and a minimum at λ₂ and the partially reflective outcoupling surface would be at the back surface (to the right in FIG. 2a) of the block 230. The transmission function embodiment having the partially reflecting outcoupler surface 231 at the front surface (the left side of block 230 in FIG. 2a) is, however, preferred since it is the radiation that outcouples directly from the chamber 102, without traversing the rear optics line-selection package 214, in which it is most significantly preferred to suppress λ₂. In addition, an interferometric outcoupler thickness at this wavelength (i.e., 157 nm) would be small, e.g., between 30 to 50 microns, for performing lineselection between lines separated by only 106 pm, such that manufacture of an interferometric outcoupler (such as set forth in the Ser. No. 09/715,803 application) using the preferred CaF₂ or otherwise VUV transparent material may be alternatively used, but is not preferred.

The outcoupler block 230 is preferably made of a block of VUV transparent material 232 such as CaF₂ or one of the other materials mentioned above. The material block 232 preferably has a special coating 234 formed on it. The coating 234 is preferably highly compounded with the block 230. Advantageously, a preferred thickness of the coating 234 between 30 to 50 microns may be, in this way, more easily manufacturable than, e.g., an interferometric outcoupler, as described above. An etalon-like interference effect is produced by the outcoupler 230 having the coating 234 formed on the block 232 to meet the objects of the invention. That is, the block 232 with the coating 234 provides an advantageous transmission function having a maximum at the selected line of the lines λ₁ and λ₂ and a transmission minimum at the unselected line, as described above. Preferably the coating is made of MgF₂, and alternatively of the one of the other materials set forth above.

FIG. 2b shows a second embodiment including the discharge chamber 102 and rear optics module 214, preferably as set forth above, and an outcoupler 236. The outcoupler 236 has a partially reflective surface 231 forming the resonator reflector of the resonator. The bulk of the block 236 is thus preferably extra-cavity. The outcoupler 236 is advantageously formed of MgF₂ which provides a periodic transmission function for suppressing the secondary line λ₂ and improving the contrast ratio. The small refractive index difference between the ordinary and extraordinary polarizations nₒ and nₑ, respectively, of the MgF₂, owing to its birefringent nature, is small enough (i.e., around 0.014) that the material thickness of the outcoupler 236 may be of the order of several millimeters. Preferably, the thickness is around 8.4 mm for producing the desired line-selective transmission, i.e., selecting λ₁ and suppressing λ₂.

The outcoupler 236 forms a highly stable, highly transparent and compact outcoupler which meets the objects of the invention. That is, the contrast ratio is advantageously increased, particularly due to the suppression of the radiation generated in the chamber 1 02 and being directly outcoupled without traversing the rear module 214.

FIG. 3a schematically shows a third resonator arrangement including the rear optics module 214 including a line-selection optic, line-selection optics, with or without line-narrowing of the selected line, or merely a HR mirror, and the discharge tube 102 with electrodes 103 coupled with a discharge circuit 104, gas handling module 106, processor (not shown), etc. as set forth above with reference to FIG. 1. The arrangement of FIG. 3a includes an output coupler 330 that may be a partially reflecting mirror (the element 330 may be a HR mirror and outcoupling may be otherwise from a reflecting surface within the laser cavity) or the outcoupler 330 may have line-selection properties as set forth herein with respect to FIGS. 2a-2b, or e.g., as set forth in the Ser. No. 09/715,803 application or Pat. No. 6,154,470 patent. The resonator of the arrangement of FIG. 3a may be arranged in any of multiple configurations as set forth above, or otherwise as understood by those skilled in the art, with line-selection, line-selection and line-narrowing of the selected line, or without line-selection or line-narrowing.

The arrangement shown at FIG. 3a includes a spectral filter 350 after the outcoupler 330, or if the element 330 is a HR mirror, then after whatever element from which the beam is outcoupled from the laser resonator. The spectral filter 350 may include a dispersion prism, two or more dispersion prisms, an interferometric device such as that set forth at the Ser. No. 09/715,803 application or an etalon, a transmission or reflection grating, a grism, one or more birefringent plates, or an element such as element 230 or 236 of FIGS. 2a-2b not having the partially reflecting surface 231 formed on it. The spectral filter 350 may select the primary line (e.g., λ₁) either reflectively or transmissively, and is arranged such that the selected primary line propagates along an optical path toward an application process, while propagation of the unselected line (e.g., λ₂) is suppressed along that optical path toward the application process. The extracavity spectral filter 350 advantageously increases the intensity ratio of the primary to secondary lines to above 100 and perhaps above 500.

The resonator of FIG. 3b shows a fourth alternative arrangement. The resonator of FIG. 3b includes the rear optics module 214 and laser chamber 102 as described above. An intracavity line-selection optic or optics 450 is used having a transmission spectrum with a maximum at the selected line (e.g., λ₁) and a minimum at the unselected line (e.g., λ₂). An output coupler 430 such as a partially reflecting mirror is located such that the line-selection optic is between the chamber 102 and the outcoupler 430, i.e., on the outcoupling side of the chamber 102.

In all of the above embodiments, preferably one or more optics for increasing the polarization of the output beam are included in the resonator. such optics may be plates arranged at or near Brewster's angle or polarizer plates and preferably Brewster windows on the chamber 102. The polarization of the beam, even though the beam only makes one or two round trips in the resonator, is preferably at least 95% (see Ser. No. 09/738,849 application, incorporated herein by reference).

In accord with the above objects, a F₂-laser emitting around 157 nm is provided including a discharge chamber filled with a laser gas including molecular fluorine and a buffer gas and having electrodes therein connected to a discharge circuit for energizing the molecular fluorine. The discharge chamber is disposed within a resonator for generating an output beam, and the laser system includes a line-selection optic for increasing a contrast ratio of intensities of two closely-spaced lines around 157 nm of more than 100.

The resonator includes one or more advantageous line selection components on the output coupling side of the chamber. Preferably, an output coupling element provides line selection in addition to output coupling of the beam. Alternatively, the output coupler and the line-selection element may be separate optical elements, e.g., as an intracavity line-selection element or a spectral filter outside the resonator may provide. A line-selection package including a beam expander before one or more dispersive and/or interference optical elements, such as prisms, gratings, etalons or other interferometric devices, etc., may be also provided on the opposite side of the chamber as the output coupler, for selecting λ₁ and suppressing λ₂.

The output coupling element preferably has an extracavity transmission spectrum characterized by interference maxima and minima spectrally located at or near λ₁ and λ₂, respectively. The interference pattern may be provided by a block output coupler made of a VUV transparent material, such as CaF₂, having a thin coating formed on it, made of, e.g., preferably MgF₂. Such block element having the coating on it may alternatively be provided before or after an otherwise typical partially reflective outcoupler. The outcoupler has a preferred partially reflecting inner surface serving as a resonator reflector. The interference pattern may also be provided by a birefringent block output coupler, or alternatively, a birefringent plate separate from the output coupler and outside the resonator near the outcoupler. The birefringent block preferably has a partially reflecting inner surface serving as a resonator reflector surface. The birefringent material used would preferably be MgF₂.

Material compositions and thicknesses of the optical elements are selected advantageously to meet the above objects of the invention. For example, the coating may be preferably 30 to 50 microns thick and is made of MgF₂. For the birefringent block, the thickness may be preferably around 8.4 mm.

In addition, a spectral filter may be provided after a partially reflecting outcoupler mirror. The spectral filter may include any of a dispersion prism or dispersion prisms, interferometric device or devices, transmission of reflection grating or grism, birefringent plate of plates, etc., or any of the line-selection optics set forth above for transmitting or reflecting the primary line λ₁ to continue to propagate toward an application process, while suppressing the secondary line λ₂.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the steps have been ordered in selected typographical sequences. However, the sequences have been selected and so ordered for typographical convenience and are not intended to imply any particular order for performing the steps, except for those claims wherein a particular ordering of steps is expressly set forth or understood by one of ordinary skill in the art as being necessary.

What is claimed is:

1. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam around 157 nm, said resonator further including:
a solid element having a transmission maximum at or near said main line λ₁ and a transmission minimum at or near a secondary line λ₂ of said plurality of closely-spaced lines to suppress said secondary line, said solid element being positioned on an output coupling side of the chamber, and
an additional line-selection package on the opposite of the output coupling side of the chamber.

2. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including:
a solid element comprising a birefringent bulk material, and said solid element having a transmission maximum at or near said main line λ₁ and a transmission minimum at or near a secondary line λ₂ of said plurality of closely-spaced lines to suppress said secondary line, said solid element being positioned on an output coupling side of the chamber, and
an additional line-selection package on the opposite of the output coupling side of the chamber.

3. The laser system of claim 2, wherein said birefringent bulk material is MgF₂.

4. The laser system of claim 3, wherein said birefringent bulk material is between 5 mm and 10 mm thick.

5. The laser system of claim 4, wherein said birefringent bulk material produces the transmission maximum and minimum.

6. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including:
a solid element comprising a VUV transparent block with a thin coating formed thereon, and said solid element having a transmission maximum at or near said main line λ₁ and a transmission minimum at or near a secondary line λ₂ of said plurality of closely-spaced lines to suppress said secondary line, said solid element being positioned on an output coupling side of the chamber, and
an additional line-selection package on the opposite of the output coupling side of the chamber.

7. The laser system of claim 6, wherein said thin coating comprises MgF₂.

8. The laser system of claim 7, wherein said block comprises a bulk portion of CaF₂.

9. The laser system of claim 7, wherein said thin coating is between 30 and 50 microns thick.

10. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including:
a solid element having a partially reflective inner surface as a resonator reflector, and said solid element having a transmission maximum at or near said main line λ₁ and a transmission minimum at or near a secondary line λ₂ of said plurality of closely-spaced lines to suppress said secondary line, said solid element for output coupling the laser beam, and
an additional line-selection package on the opposite of the output coupling side of the chamber.

11. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including:
a solid element comprising a birefringent bulk material and having a partially reflective inner surface as a resonator reflector, and said solid element having a transmission maximum at or near said main line λ₁ and a transmission minimum at or near a secondary line λ₂ of said plurality of closely-spaced lines to suppress said secondary line, said solid element for outcoupling the laser beam, and
an additional line-selection package on the opposite of the output coupling side of the chamber.

12. The laser system of claim 11, wherein said birefringent bulk material is MgF₂.

13. The laser system of claim 12, wherein said birefringent bulk material is between 5 mm and 10 mm thick.

14. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including:
a solid element comprising a VUV transparent block with a thin coating formed thereon and having a partially reflective inner surface as a resonator reflector, and said solid element having a transmission maximum at or near said main line λ₁ and a transmission minimum at or near a secondary line λ₂ of said plurality of closely-spaced lines to suppress said secondary line, said solid element for outcoupling the laser beam, and
an additional line-selection package on the opposite of the output coupling side of the chamber.

15. The laser system of claim 14, wherein said thin coating comprises MgF₂.

16. The laser system of claim 15, wherein said block comprises a bulk portion of CaF₂.

17. The laser system of claim 15, wherein said thin coating is between 30 and 50 microns thick.

18. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including a solid element having a partially reflective inner surface as a resonator reflector, and said solid element having a transmission maximum at or near said main line λ₁ and a transmission minimum at or near a secondary line λ₂ of said plurality of closely-spaced lines to suppress said secondary line, said solid element for output coupling the laser beam.

19. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including a solid element comprising a birefringent bulk material and having a partially reflective inner surface as a resonator reflector, and said solid element having a transmission maximum at or near said main line λ₁ and a transmission minimum at or near a secondary line λ₂ of said plurality of closely-spaced lines to suppress said secondary line, said solid element for outcoupling the laser beam.

20. The laser system of claim 19, wherein said birefringent bulk material is MgF₂.

21. The laser system of claim 20, wherein said birefringent bulk material is between 5 mm and 10 mm thick.

22. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including a solid element comprising a VUV transparent block with a thin coating formed thereon and having a partially reflective inner surface as a resonator reflector, and said solid element having a transmission maximum at or near said main line λ₁ and a transmission minimum at or near a secondary line λ₂ of said plurality of closely-spaced lines to suppress said secondary line, said solid element for outcoupling the laser beam.

23. The laser system of claim 22, wherein said thin coating comprises MgF₂.

24. The laser system of claim 23, wherein said block comprises a bulk portion of CaF₂.

25. The laser system of claim 23, wherein said thin coating is between 30 and 50 microns thick.

26. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam around 157 nm, said resonator further including a solid element having a transmission maximum at or near said main line λ₁ and a transmission minimum at or near a secondary line λ₂ of said plurality of closely-spaced lines to suppress said secondary line, said solid element being positioned on an output coupling side of the chamber, and
an amplifier for boosting an energy of the laser beam generated from the resonator.

27. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including a solid element comprising a birefringent bulk material, and said solid element having a transmission maximum at or near said main line λ₁ and a transmission minimum at or near a secondary line λ₂ of said plurality of closely-spaced lines to suppress said secondary line, said solid element being positioned on an output coupling side of the chamber, and
an amplifier for boosting an energy of the laser beam generated from the resonator.

28. The laser system of claim 27, wherein said birefringent bulk material is MgF₂.

29. The laser system of claim 28, wherein said birefringent bulk material is between 5 mm and 10 mm thick.

30. The laser system of claim 29, wherein said birefringent bulk material produces the transmission maximum and minimum.

31. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a plurality of electrodes within the discharge chamber and connected to a discharge circuit for energizing the molecular fluorine; and
a resonator including the discharge chamber for generating a laser beam, said resonator further including a solid element comprising a VUV transparent block with a thin coating formed thereon, and said solid element having a transmission maximum at or near said main line λ₁ and a transmission minimum at or near a secondary line λ₂ of said plurality of closely-spaced lines to suppress said secondary line, said solid element being positioned on an output coupling side of the chamber, and
an amplifier for boosting an energy of the laser beam generated from the resonator.

32. The laser system of claim 31, wherein said thin coating comprises MgF₂.

33. The laser system of claim 32, wherein said block comprises a bulk portion of CaF₂.

34. The laser system of claim 32, wherein said thin coating is between 30 and 50 microns thick.

35. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine; and
a resonator including the discharge chamber for generating a laser beam around 157 nm, said resonator further including a solid element having a transmission maximum at or near said main line λ₁ and a transmission minimum at or near a secondary line λ₂ of said plurality of closely-spaced lines to suppress said secondary line, said solid element being positioned on an output coupling side of the chamber, and
an enclosure maintained substantially free of VUV photoabsorbing species wherein said laser beam propagates within said enclosure between said resonator and an application process.

36. The laser system of claim 35, wherein said gas handling module is configured for adding gas to and releasing gas from the discharge chamber for controlling a total pressure of said gas mixture within said discharge chamber.

37. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine;
a resonator including the discharge chamber for generating a laser beam, said resonator further including a solid element comprising a birefringent bulk material, and said solid element having a transmission maximum at or near said main line λ₁ and a transmission minimum at or near a secondary line λ₂ of said plurality of closely-spaced lines to suppress said secondary line, said solid element being positioned on an output coupling side of the chamber; and
an enclosure maintained substantially free of VUV photoabsorbing species wherein said laser beam propagates within said enclosure between said resonator and an application process.

38. The laser system of claim 37, wherein said birefringent bulk material is MgF₂.

39. The laser system of claim 38, wherein said birefringent bulk material is between 5 mm and 10 mm thick.

40. The laser system of claim 39, wherein said birefringent bulk material produces the transmission maximum and minimum.

41. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine; and
a resonator including the discharge chamber for generating a laser beam, said resonator further including a solid element comprising a VUV transparent block with a thin coating formed thereon, and said solid element having a transmission maximum at or near said main line λ₁ and a transmission minimum at or near a secondary line λ₂ of said plurality of closely-spaced lines to suppress said secondary line, said solid element being positioned on an output coupling side of the chamber, and
an enclosure maintained substantially free of VUV photoabsorbing species wherein said laser beam propagates within said enclosure between said resonator and an application process.

42. The laser system of claim 41, wherein said thin coating comprises MgF₂.

43. The laser system of claim 42, wherein said block comprises a bulk portion of CaF₂.

44. The laser system of claim 42, wherein said thin coating is between 30 and 50 microns thick.

45. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine; and
a resonator including the discharge chamber for generating a laser beam around 157 nm, said resonator further including a solid element having a reflectivity maximum at or near said main line λ₁ and a reflectivity minimum at or near a secondary line λ₂ of said plurality of closely-spaced lines to suppress said secondary line, said solid element for outcoupling the laser beam, and
an enclosure maintained substantially free of VUV photoabsorbing species wherein said laser beam propagates within said enclosure between said resonator and an application process.

46. The laser system of claim 45, wherein said gas handling module is configured for adding gas to and releasing gas from the discharge chamber for controlling a total pressure of said gas mixture within said discharge chamber.

47. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine;
a resonator including the discharge chamber for generating a laser beam, said resonator further including a solid element comprising a birefringent bulk material, and said solid element having a reflectivity maximum at or near said main line λ₁ and a reflectivity minimum at or near a secondary line λ₂ of said plurality of closely-spaced lines to suppress said secondary line, said solid element for output coupling said laser beam; and
an enclosure maintained substantially free of VUV photoabsorbing species wherein said laser beam propagates within said enclosure between said resonator and an application process.

48. The laser system of claim 47, wherein said birefringent bulk material is MgF₂.

49. The laser system of claim 48, wherein said birefringent bulk material is between 5 mm and 10 mm thick.

50. The laser system of claim 49, wherein said birefringent bulk material produces the reflectivity maximum and minimum.

51. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine; and
a resonator including the discharge chamber for generating a laser beam, said resonator further including a solid element comprising a VUV transparent block with a thin coating formed thereon, and said solid element having a reflectivity maximum at or near said main line λ₁ and a reflectivity minimum at or near a secondary line λ₂ of said plurality of closely-spaced lines to suppress said secondary line, said solid element for output coupling the laser beam; and
an enclosure maintained substantially free of VUV photoabsorbing species wherein said laser beam propagates within said enclosure between said resonator and an application process.

52. The laser system of claim 51, wherein said thin coating comprises MgF₂.

53. The laser system of claim 52, wherein said block comprises a bulk portion of CaF₂.

54. The laser system of claim 52, wherein said thin coating is between 30 and 50 microns thick.

55. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine; and
a resonator including the discharge chamber for generating a laser beam around 157 nm, said resonator further including a solid element for selecting a main line λ₁ and suppressing a secondary line λ₂ of said plurality of closely-spaced lines, said solid element being disposed on an output coupling side of said discharge chamber, and an additional line-selection package on the opposite of the output coupling side of the chamber; and
an enclosure maintained substantially free of VUV photoabsorbing species wherein said laser beam propagates within said enclosure between said resonator and an application process.

56. The laser system of claim 55, wherein said gas handling module is configured for adding gas to and releasing gas from the discharge chamber for controlling a total pressure of said gas mixture within said discharge chamber.

57. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine;
a resonator including the discharge chamber for generating a laser beam, said resonator further including a solid element comprising a birefringent bulk material, and said solid element for selecting a main line λ₁ and suppressing a secondary line λ₂ of said plurality of closely-spaced lines, said solid element being disposed on an output coupling side of said discharge chamber, and an additional line-selection package on the opposite of the output coupling side of the chamber; and
an enclosure maintained substantially free of VUV photoabsorbing species wherein said laser beam propagates within said enclosure between said resonator and an application process.

58. The laser system of claim 57, wherein said birefringent bulk material is MgF₂.

59. The laser system of claim 58, wherein said birefringent bulk material is between 5 mm and 10 mm thick.

60. The laser system of claim 59, wherein said birefringent bulk material produces the reflectivity maximum and minimum.

61. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine; and
a resonator including the discharge chamber for generating a laser beam, said resonator further including a solid element comprising a VUV transparent block with a thin coating formed thereon, and said solid element for selecting a main line λ₁ and for suppressing a secondary line λ₂ of said plurality of closely-spaced lines, said solid element being disposed on an output coupling said of said discharge chamber, and an additional line-selection package on the opposite of the output coupling side of the chamber; and
an enclosure maintained substantially free of VUV photoabsorbing species wherein said laser beam propagates within said enclosure between said resonator and an application process.

62. The laser system of claim 61, wherein said thin coating comprises MgF₂.

63. The laser system of claim 62, wherein said block comprises a bulk portion of CaF₂.

64. The laser system of claim 62, wherein said thin coating is between 30 and 50 microns thick.

65. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine; and
a resonator including the discharge chamber for generating a laser beam around 157 nm, said resonator further including line-selection optics for selecting a main line λ₁ and suppressing a secondary line λ₂ of said plurality of closely-spaced lines, said line-selection optics including a line-selection package on the opposite of an output coupling side of the chamber, such that a contrast ratio of said main line to said secondary line in said laser beam is at least 100; and
an enclosure maintained substantially free of VUV photoabsorbing species wherein said laser beam propagates within said enclosure between said resonator and an application process.

66. A molecular fluorine laser system emitting a narrow bandwidth laser beam and having efficient line-selection of a main line λ₁ of a plurality of closely-spaced lines around 157 nm, comprising:
a discharge chamber filled with a laser gas including molecular fluorine and a buffer gas;
a gas handling module for periodically replenishing the molecular fluorine in the discharge chamber for maintaining said gas mixture at a selected composition;
a plurality of electrodes within the discharge chamber and connected to a discharge circuit for energizing the molecular fluorine; and
a resonator including the discharge chamber for generating a laser beam around 157 nm, said resonator further including line-selection optics for selecting a main line λ₁ and suppressing a secondary line λ₂ of said plurality of closely-spaced lines, said line-selecting optics including a line-selection package on the opposite of an output coupling side of the chamber, such that a contrast ratio of said main line to said secondary line in said laser beam is at least 500; and
an enclosure maintained substantially free of VUV photoabsorbing species wherein said laser beam propagates within said enclosure between said resonator and an application process.
